(19) United States
(12) Patent Application Publication
(10) Pub. No.: US 2016/0138537 A1
(43) Pub. Date: May 19, 2016

(54) FUEL DELIVERY SYSTEM WITH PARTIAL PRESSURE RELIEF VALVE ON THE DRIVE LINE OF A SUCTION JET PUMP

(71) Applicant: ROBERT BOSCH GMBH, Stuttgart (DE)

(72) Inventors: Hans-Peter Braun, Renfrizhausen (DE); Martin Beyer, Marbach (DE)

(21) Appl. No.: 14/901,159

(22) PCT Filed: May 15, 2014
(86) PCT No.: PCT/EP2014/059923

§ 371 Date: Dec. 28, 2015

(30) Foreign Application Priority Data
Jun. 26, 2013 (DE) 10 2013 212 267.5

(51) Int. Cl. F02M 37/02; F02M 37/22

(52) U.S. Cl. CPC F02M 37/025; F02M 37/22; F02M 2037/226

(57) ABSTRACT

A fuel delivery system (1) and a corresponding production method for producing a fuel delivery system (1) are proposed. The fuel delivery system (1) has a fuel filter (3) which purifies a fuel (9) delivered from an accumulator pot (5) to an internal combustion engine (7). Furthermore, the fuel delivery system (1) has a suction jet pump (15) for filling the accumulator pot (5) with fuel (9) from a fuel tank (11). A drive line (17) connects the suction jet pump (15) to the fuel filter (3). In this case, there is provided on the drive line (17) a first pressure valve (19) which opens in the direction of the suction jet pump (15) when a pressure on the fuel filter side exceeds a first threshold value.

### BACKGROUND OF THE INVENTION

A fuel delivery system can be disposed in a fuel tank of a motor vehicle and be used to supply an internal combustion engine with fuel. In so doing, the fuel delivery system can have a fuel filter in order to clean the fuel of undesirable particles before being supplied to the internal combustion engine.

When parking or shutting down the motor vehicle, the fuel can degas in the fuel tank and particularly in the fuel filter. When restarting the vehicle, this can lead to higher pressure build-up times in the fuel filter because the gases must initially be compressed and liquefied.

In order to prevent vapor bubbles from developing, fuel filters can be held under pressure, in particular under system pressure, when the vehicle has been shut down. This leads, however, to the fuel filter being subjected to a higher level of stress over the service life thereof.

### SUMMARY OF THE INVENTION

A need for an improved fuel delivery system and a corresponding production method for a fuel delivery system may therefore exist, which especially allows the stress on the fuel filter to be reduced over the service life thereof.

Features, details and possible advantages of a device according to the embodiments of the invention are discussed below in detail.

A fuel delivery system is presented according to a first aspect of the invention. The fuel delivery has a fuel filter which purifies or filters a fuel delivered from an accumulator pot to an internal combustion engine. Furthermore, the fuel delivery system has a suction jet pump (SJP) for filling the accumulator with fuel from a fuel tank. The fuel filter is thereby hydraulically connected to the suction jet pump via a drive line. A first pressure valve is provided on the drive line, said pressure valve automatically opening in the direction of the suction jet pump when a pressure in the fuel filter exceeds a first threshold value.

In other words, the concept of the invention is based on integrating a pressure valve having a defined opening pressure into a feed of the suction jet pump. In this case, the opening pressure lies between a vapor pressure of the fuel and the system pressure. That means the opening pressure of the first pressure valve can be selected at the pressure limit where an outgassing of the fuel would occur. At said pressure limit, a partial system pressure is therefore applied to the fuel filter after the vehicle has been shut down.

As a result, the pressure load and thus the wear on the fuel filter or the filter housing can advantageously be reduced when the vehicle is parked. At the same time, an outgassing of the fuel and therefore unduly delayed restarting times of the internal combustion engine can be prevented.

Thanks to the inventive configuration of the fuel delivery system, cost effective filter housings, for example consisting of polyoxymethylene (POM), can be used even at higher system pressures while driving without sacrificing the service life of the fuel filter. The higher system pressures while driving can be compensated by virtue of the fact that the fuel filter is held at a lower pressure when parked than when the vehicle is travelling. In this way, the overall load on the fuel filter does not increase across the service life thereof in comparison to known fuel delivery systems.

By disposing the first pressure valve in the drive line which connects the fuel filter to the suction jet pump, the overflow quantity of the fuel can be used to feed the suction jet pump. That means that the first pressure valve can allow a fuel quantity which is delivered from the fuel pump to the accumulator pot and is not needed by the internal combustion engine to pass into the drive line as an overflow quantity. In this way, the overflow quantity can be used to feed the suction jet pump. This facilitates in turn a higher degree of efficiency of the fuel delivery system in comparison to solutions up until now, in which the overflow quantity was allowed to flow off, i.e. was, e.g., fed back to the fuel tank.

The fuel delivery system can, for example, be used in a fuel tank of a motor vehicle. The motor vehicle can, for example, be a motor vehicle with a combustion engine, such as, e.g., an internal combustion engine. The motor vehicle can, furthermore have an electric drive and be embodied as a hybrid vehicle. In so doing, the fuel delivery system can have an accumulator pot respectively reservoir provided in the fuel tank. The accumulator pot is then disposed as close as possible to the bottom of the fuel tank. In addition to the fuel filter, an electric fuel pump (EFP) including, if applicable, a pre-filter and a suction jet pump can be provided in the fuel tank and particularly in the accumulator pot.

The fuel filter can be designed as a fine filter or, respectively, lifetime filter. In this regard, the fuel filter is designed to purify the fuel of undesirable particles, said fuel being led from the fuel tank respectively from the accumulator to the internal combustion engine. The fuel filter and particularly the filter housing can be designed to be used at a system pressure of 7 to 8 bar.

The fuel can, for example, be pumped via a suction line of the suction jet pump out of the fuel tank into the interior of the accumulator pot. The fuel can then be pumped out of the accumulator pot by means of a fuel pump, in particular an electric fuel pump, to the filter and subsequently through a feed line to a fuel injection system of the internal combustion engine.

The suction jet pump can be arranged at the accumulator pot and be designed as a horizontal or vertical suction pump. Fuel is delivered directly from the fuel filter to a suction line. A constriction is provided at the connection point between the suction line and the drive line. The cross section in the suction line increases again downstream of the constriction. As a result of the enlargement of the cross section, the pressure in the suction pipe drops; thus enabling fuel from the fuel tank to be suctioned through the suction pipe into the accumulator pot.

By supplying the suction jet pump with fuel directly from the fuel filter, a clean feed of the suction jet pump can be ensured. By means of the direct feed of the suction jet pump from the fuel filter, the service life of the electric fuel pump can be increased. By providing the first pressure valve on the drive line of the suction jet pump as is described further below, the suction jet pump can furthermore be “turned on and off”.

The first pressure valve can also be referred to as the partial pressure relief valve, the pressure control valve or as the overpressure valve. The first pressure valve is disposed on or, respectively, in the drive line. The first pressure valve has a defined opening pressure. That means the pressure valve only opens when a predefined first pressure threshold value has been exceeded. In this case, the first pressure valve opens automatically upon the first threshold value having been exceeded, i.e. without the need of an actuation. The first pressure valve particularly limits the pressure maximally prevailing in the fuel filter when the fuel delivery system has been shut down. The first pressure valve can, for example, have a seal and a spring. The opening pressure or, respectively, the first threshold value can be determined by means of the spring, for example via the spring constant.

According to one exemplary embodiment of the invention, the first threshold value lies between a vapor pressure of the fuel at a shutdown temperature of the fuel delivery system or, respectively, the motor vehicle and a system pressure. The vapor pressure of the fuel can thereby correspond to a pressure limit, below which an outgassing of the fuel would occur. In so doing, said vapor pressure can be dependent on the temperature as well as the type of fuel. The shutdown temperature can thereby lie, for example, between 0° C. and 60° C.

When selecting the first threshold value or, respectively, opening pressure of the first pressure valve, a worst case scenario can, for example, be taken into account. That means that the first threshold value is selected such that the first pressure valve only opens at the highest possible shutdown temperature in the fuel filter of, for example, 60° C. and when the fuel has the highest vapor pressure if the partial system pressure in the fuel filter is high enough to prevent an outgassing.

According to a further exemplary embodiment of the invention, the first threshold value lies between 1.5 bar and 4 bar. The first threshold value is preferably greater than 2.2 bar. The first threshold value particularly lies at 2.5 bar.

According to a further exemplary embodiment of the invention, the fuel delivery system further comprises a control unit and a fuel pump for delivering fuel out of the accumulator pot to the fuel filter. The control unit is designed to actuate the fuel pump in such a way that a feed of the suction jet pump is shut down by the fuel pump being operated at a pressure which is smaller than the first threshold value of the first pressure valve.

In other words, the feed of the suction jet pump, i.e. the supply of the suction jet pump with the propellant: fuel, can be turned “off” and “on” via the drive line. This can take place by a corresponding actuation of the fuel pump, which can be embodied as an electric fuel pump. In this way, a smaller power consumption of the fuel delivery system can be implemented. The fuel delivery system can, for example, be operated when there is a sufficiently high tank fill level in the fuel tank and when normal operating parameters of the fuel injection system or, respectively, the internal combustion engine are at a pressure that lies below the first threshold value. In this case, the first pressure valve does not open. As a result, a smaller delivery volume of the fuel pump is sufficient to operate the fuel delivery system.

According to a further exemplary embodiment of the invention, the fuel delivery system additionally comprises a feed line which is disposed between the fuel filter and the internal combustion engine. A second pressure valve is provided on or, respectively, in the feed line, which pressure valve opens towards the fuel tank if a pressure in the feed line exceeds a second threshold value. The second threshold value is thereby greater than the first threshold value.

The feed line can also be referred to as the pressure line. The second pressure valve can, similarly to the first pressure valve, be designed, for example, as a spring-loaded pressure relief valve and have a predetermined opening pressure. The opening pressure of the second pressure valve is higher than is the case for the first pressure valve because the temperatures increase towards the internal combustion engine and thus a higher pressure on the internal combustion engine side of the fuel delivery system is appropriate in order to prevent the fuel from outgassing. The second pressure valve opens in the direction of the fuel tank and, for example, allows excess delivered fuel to run out of the feed line back into the fuel tank or, respectively, into the accumulator pot.

According to a further exemplary embodiment of the invention, the second threshold value lies between 5 bar and 7.5 bar. The second threshold value lies preferably at 7.5 bar.

According to a further exemplary embodiment of the invention, a first back-pressure valve is provided between the fuel pump and the fuel filter, which opens in the direction of the fuel filter. The first back-pressure valve can also be referred to as a “check valve”. In so doing, the first check valve is disposed on or, respectively, in a line between the fuel pump and the fuel filter.

The third threshold value or, respectively, the opening pressure of the first check valve can be substantially less than the first and the second threshold value. For example, the third threshold value can lie between 1 mbar and 2.5 bar. In particular, the third threshold value can, for example, correspond to a static pressure of the fuel column across the check valve. The first check valve can, for example, prevent fuel from escaping the system in the case of an accident and if the vehicle is in an upside down position.

According to a further exemplary embodiment of the invention, a second check valve is provided on the feed line between the internal combustion engine and the fuel filter, said second check valve opening in the direction of the internal combustion engine. The second check valve can be designed similarly or identically to the first check valve and meets a similar or identical aim. The first and second check valve can particularly prevent an undesirable backflow of the fuel.

According to a further exemplary embodiment of the invention, the first pressure valve is disposed above the fuel filter if the fuel delivery system is installed in a fuel tank of a motor vehicle. The drive line can, for example, branch off in an upper region of the fuel filter and particularly on a cover of the fuel filter. By disposing the first pressure valve above the fuel filter or, respectively, in the upper region of the fuel filter, it can be ensured that, in the event that gases nevertheless form in the fuel filter, said gases can escape, for example, across the first pressure valve and the suction jet pump.

According to a second aspect of the invention, a method for producing a fuel delivery system described above is presented. The method has the following steps: providing a fuel filter in a fuel tank for purifying fuel which is delivered from an accumulator pot to an internal combustion engine; providing a suction jet pump in a fuel tank for filling the accumulator pot with fuel from a fuel tank; hydraulically connecting the suction jet pump to the fuel filter via a drive line; disposing a first pressure valve on the drive line; designing the first pressure valve in such a way that said valve opens in the direction of the suction jet pump when a pressure on the fuel filter side exceeds a first threshold value.

### BRIEF DESCRIPTION OF THE DRAWINGS

Further features and advantages of the present invention are made clear to the person skilled in the art by the following description of exemplary embodiments, which are, however, not to be interpreted so as to limit the invention, with reference to the attached drawings. In the drawings:

FIG. 1 shows a schematic design of a fuel delivery system according to one exemplary embodiment of the invention; and

FIG. 2 shows vapor pressure curves of different fuels.

### DETAILED DESCRIPTION

All drawings are only schematic depictions of devices according to the invention or, respectively of constituent parts thereof according to exemplary embodiments of the invention.

Particularly spacings and size relations are not reflected true to scale in the figures. Corresponding elements are provided with the same reference numerals in the different drawings.

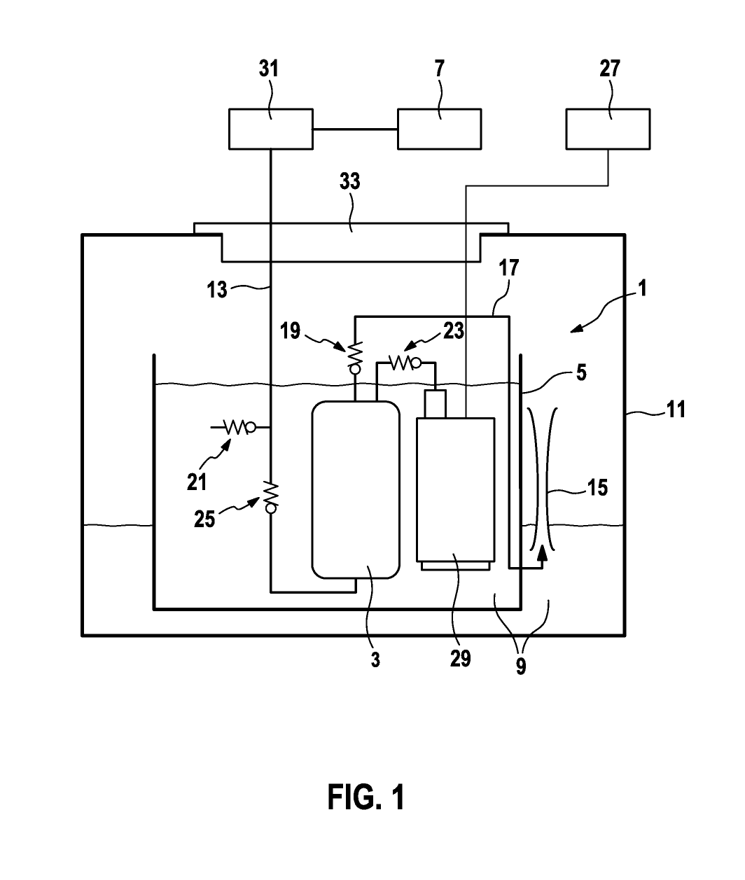

In FIG. 1, the fuel delivery system 1 is disposed at an accumulator pot 5 in a fuel tank 11. The accumulator pot 5 is disposed as close as possible to the bottom of the fuel tank 11 and accumulates fuel 9 in order to ensure a supply of fuel 9 to the internal combustion engine 7 even when traversing curves and when the resulting sloshing movements of the fuel 9 in the fuel tank 11 occur.

The fuel delivery system 1 comprises a fuel filter 3, a fuel pump 29 and a suction jet pump 15. The fuel pump 29 delivers fuel 9 from the accumulator pot 5 to the internal combustion engine 7. In so doing, the fuel 9 passes the fuel filter 3 on the way to the internal combustion engine 7 and is cleaned of undesirable particles. Downstream of the fuel filter 3, the fuel 9 can be conveyed in the direction of the internal combustion engine 7 via a feed line 13. The feed line 13 extends through a tank flange 33 to a fuel injection system 31 which supplies the fuel 9 to the internal combustion engine 7.

The suction jet pump 15 is schematically depicted in FIG. 1 on the side of the accumulator pot 5. The suction jet pump 15 can preferably run along the deepest point, i.e., for example, on the bottom of the accumulator pot 5. The suction jet pump 15 makes sure that the accumulator pot 5 remains filled with fuel 9 independently of the fill level in the fuel tank 11. The suction jet pump 15 is driven with fuel 9 provided via a drive line 17. The fuel 9 travels directly from the fuel filter 3 into the drive line 17 and is guided via a throttle element, for example a nozzle, into a suction line connected to the accumulator pot 5. The propulsion jet leaving the nozzle into the suction line entrains fuel 9 from the suction line; thus enabling the fuel of the propulsion jet and the entrained fuel 9 to travel across a mixing channel into the accumulator pot 5.

If the motor vehicle is shut down, i.e. if, for example, the internal combustion engine 7 is no longer running and, as the case may be, the ignition key is pulled out of the ignition switch, the pressure in the fuel delivery system 1 drops. In known fuel delivery systems, this can cause the fuel situated in the system and particularly in the fuel filter to outgas. An outgassing of the fuel 9 leads in turn to delayed starting times because the gas has to first be compressed prior to start-up. If the fuel filter, on the other hand, is also held at the operating system pressure of, for example, 7.5 bar when the vehicle is shut down, this can then lead to premature wear to the fuel filter.

In the fuel delivery system 1 according to the invention 1, a first pressure valve 19 is provided on the drive line 17, said first pressure valve automatically opening in the direction of the suction jet pump 15 if the pressure in the fuel filter 3 exceeds a first threshold value. That means that a first pressure valve 19 designed as a partial pressure valve is provided at an outlet of the fuel filter 3. The opening pressure of the first pressure valve 19 lies between the relevant vapor pressure of the fuel 9 at the boundary to outgassing and the operating system pressure.

As a result, a stress on the filter housing is significantly reduced over the service life of the fuel filter 3. The time duration having high pressures is substantially reduced because only a partial pressure is present in the fuel filter 3 when the vehicle is shut down. This partial pressure ensures that the fuel 9 does not outgas. In this way, short restarting times of the internal combustion engine 7 can be ensured.

During the operation of the fuel delivery system 1, an overflow quantity, i.e. a fuel quantity delivered by the fuel pump 29 and not currently required by the internal combustion engine 7, can be used to feed the suction jet pump 15 thanks to the inventive configuration of the fuel delivery system 1. In comparison to known systems, in which the overflow quantity is freely discharged into the accumulator pot, an increase in the overall efficiency of the fuel delivery system 1 is thereby achieved.

The fuel delivery system 1 can furthermore comprise a control unit 27, which is connected functionally or, respectively, electrically to the fuel pump 29 and can actuate the same. The feed of the suction jet pump 15 via the drive line 17 can be “turned on and off” by a suitable selection of the first threshold value of the first pressure valve 19 and a corresponding actuation of the fuel pump 29 by means of the control unit 27. This can, for example, take place by the fuel pump 29 being operated at a lower output or, respectively, at a lower pressure so that the first threshold value is not exceeded and the first pressure valve 19 remains closed. In this way, the power consumption of the fuel delivery system 1 can be further reduced in this operating state. For example, this can be useful when the tank fill level is sufficiently high and the normal operating parameters of the fuel injection system 31 or, respectively, the internal combustion engine 7 are in effect.

In addition, a second pressure valve 21 can be provided on the feed line 13, said second pressure valve opening to the fuel tank 11 if a pressure in the feed line 13 exceeds a second threshold value. The second threshold value lies, for example, between 5 bar and 7.5 bar and is greater than the first threshold value, which, for example, lies between 1.5 bar and 4 bar. The second pressure valve 21 has a higher opening pressure because the temperatures increase in the direction of the internal combustion engine 7 and higher pressures are required here in order to prevent an outgassing of the fuel 9.

A first check valve 23 can furthermore be provided between the fuel pump 29 and the fuel filter 3, said first check valve opening in the direction of the fuel filter 3. In addition, a second check valve 25 can be provided on the feed line 13 between the internal combustion engine 7 and the fuel filter 3, said second check valve opening in the direction of the internal combustion engine 7. The first check valve 23 and the second check valve 25 can thereby prevent an undesirable back flow of the fuel 9.

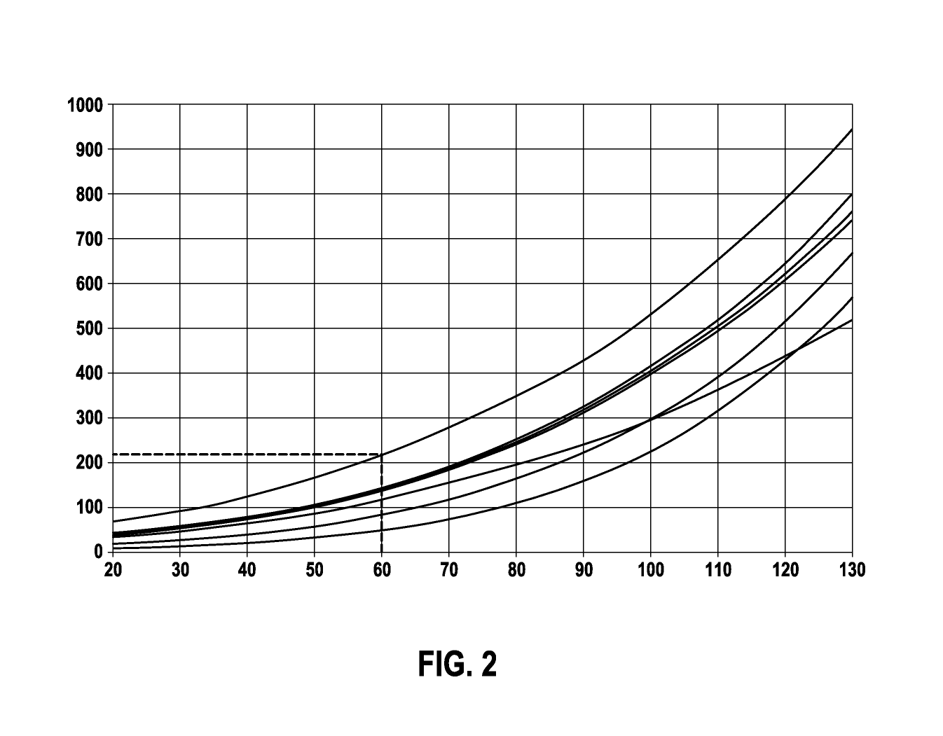

In FIG. 2, vapor pressure curves of different fuels are depicted in a diagram. A temperature in ° C. is plotted here on the x-axis. A vapor pressure in kPa is plotted on the y-axis. Different fuels can have different vapor pressure profiles as a function of the temperature. For example, a fuel at a temperature of 60° C. can have a vapor pressure of approximately 220 kPa or 2.2 bar. Another fuel can have a vapor pressure of 50 kPa or 0.5 bar at the same temperature. The individual vapor pressures can be taken into account when selecting the first threshold value.

In closing, it should be noted that expressions like “comprising” or something similar should not exclude further elements or steps from being provided. In addition, it should be pointed out that “a” or “one” do not exclude a “plurality”. Furthermore, the features described in combination with the different embodiments can be arbitrarily combined with one another. It is further noted that the reference signs in the claims are not to be interpreted in a manner which limits the scope of the claims.

1. A fuel delivery system (1) comprising:
a fuel filter (3) which purifies a fuel (9) delivered from an accumulator pot (5) to an internal combustion engine (7); and
a suction jet pump (15) for filling the accumulator pot (5) with fuel (9) from a fuel tank (11);
wherein a drive line (17) connects the suction jet pump (5) to the fuel filter (3); and
wherein a first pressure valve (19) is provided on the drive line (17), said first pressure valve automatically opening in a direction of the suction jet pump (15) when a pressure on the fuel filter side exceeds a first threshold value.

2. The fuel delivery system (1) according to claim 1,
wherein the first threshold value lies between a vapor pressure of the fuel (9) at a shutdown temperature of the fuel delivery system (1) and a system pressure.

3. The fuel delivery system (1) according to claim 1,
wherein the first threshold value lies between 1.5 bar and 4 bar.

4. The fuel delivery system (1) according to claim 1, further comprising:
a control unit (27); and
a fuel pump (29) for delivering fuel (9) from the accumulator pot (5) to the fuel filter (3);
wherein the control unit (27) is configured to actuate the fuel pump (29) in such a way that a feed of the suction jet pump (15) is shut down by the fuel pump (29) being operated at a pressure which is smaller than the first threshold value of the first pressure valve (19).

5. The fuel delivery system (1) according to claim 1, further comprising:
a feed line (13) which is provided between the fuel filter (3) and the internal combustion engine (7);
wherein a second pressure valve (21) is provided on the feed line (13), said second pressure valve opening to the fuel tank (11) when a pressure in the feed line (13) exceeds a second threshold value; and
wherein the second threshold value is greater than the first threshold value.

6. The fuel delivery system (1) according to claim 5,
wherein the second threshold value lies between 5 bar and 7.5 bar.

7. The fuel delivery system (1) according to claim 4,
wherein a first check valve (23) is provided between the fuel pump (29) and the fuel filter (3), said first check valve opening in a direction of the fuel filter (3).

8. The fuel delivery system (1) according to claim 5,
wherein a second check valve (25) is provided on the feed line (13) between the internal combustion engine (7) and the fuel filter (3), said second check valve opening in a direction of the internal combustion engine (7).

9. The fuel delivery system (1) according to claim 1,
wherein the first pressure valve (19) is disposed above the fuel filter (3) if the fuel delivery system (1) is installed in a fuel tank (11) of a motor vehicle.

10. A method for producing a fuel delivery system (1) according to claim 1, the method comprising the following steps:
providing a fuel filter (3) in a fuel tank (11) for purifying fuel (9) which is delivered from an accumulator pot (5) to an internal combustion engine (7);
providing a suction jet pump (15) in the fuel tank (11) for filling the accumulator pot (5) with fuel (9) from a fuel tank (11),
connecting the suction jet pump (15) to the fuel filter (3) via a drive line (17); and
disposing a first pressure valve (19) on the drive line (17)
in such a way that said valve opens in a direction of the suction jet pump (15) when a pressure on a fuel filter side exceeds a first threshold value.
